(19) United States
(12) Patent Application Publication
(10) Pub. No.: US 2020/0095505 A1
(43) Pub. Date: Mar. 26, 2020

(54) METHOD AND DEVICE FOR THE CATALYTIC PRESSURELESS DEPOLYMERIZATION OF HYDROCARBON-CONTAINING SUBSTANCES

(71) Applicant: TGE IP LLC, Dover, DE (US)

(72) Inventor: Christian KOCH, Buttenheim (DE)

(21) Appl. No.: 16/473,040

(22) PCT Filed: Jun. 13, 2017
(86) PCT No.: PCT/DE2017/000165

§ 371 Date: Jun. 24, 2019

(51) Int. Cl. C10G 1/00; C10G 1/02; C10G 1/08; C10G 11/22; B01J 10/00; B01J 19/00; B01J 19/18; B01D 3/14

(52) U.S. Cl. CPC C10G 1/002; C10G 1/02; C10G 1/08; C10G 11/22; B01J 10/00; C10G 2400/04; B01J 19/18; B01D 3/14; C10G 2300/1011; C10G 2300/1003; B01J 19/0053

(57) ABSTRACT

A method or catalytic compressed air conversion of hydrocarbonaceous substances to oil has the steps of: providing a hydrocarbonaceous substance and a catalyst oil in a mixing turbine, mixing the catalyst oil with the hydrocarbonaceous substance to give a mixture, where the step of mixing comprises producing heat for a catalytic oxidation in the mixing turbine, providing the distillation device downstream of the mixing turbine, removing liquid constituents of the mixture into the distillation device, distilling the liquid constituents, and collecting oil and water, and is characterized in that the step of mixing comprises introducing oxygen into the mixing turbine. An apparatus with which this method can be employed has a mixing turbine comprising a first feed for a catalyst oil and a hydrocarbonaceous substance and an outlet for liquid constituents after a catalytic oxidation. In addition, such an apparatus comprises a distillation device for distilling the liquid constituents led out of the mixing turbine and a collecting device for collecting oil and water separated out from the distillation device, wherein the mixing turbine has a second feed for oxygen.

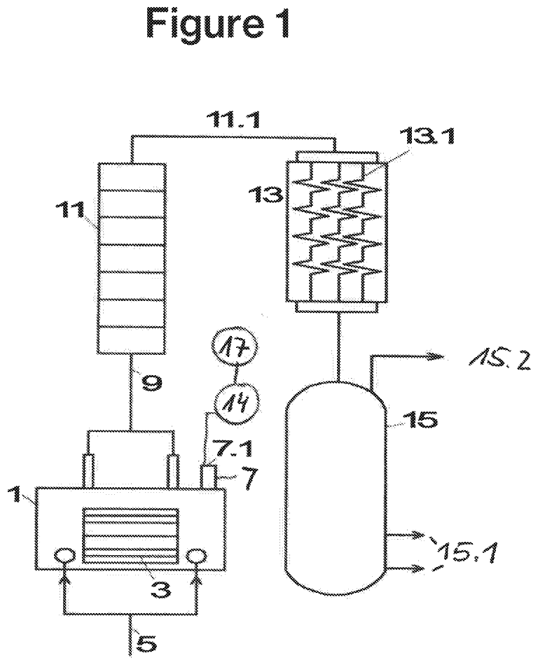

The present invention relates to a method of catalytic ambient-pressure conversion of hydrocarbonaceous substances to oil, comprising the steps of providing a hydrocarbonaceous substance and a catalyst oil in a mixing turbine; mixing the catalyst oil with the hydrocarbonaceous substance to give a mixture; where the step of mixing comprises producing heat for a catalytic oxidation in the mixing turbine; providing a distillation device downstream of the mixing turbine; removing liquid constituents of the mixture into the distillation device; distilling the liquid constituents; and collecting oil and water.

The present invention also relates to an apparatus for catalytic ambient-pressure conversion of hydrocarbonaceous substances to oil, having a mixing turbine comprising a first feed for a catalyst oil and a hydrocarbonaceous substance and an outlet for liquid constituents after a catalytic oxidation; having a distillation device for distilling the liquid constituents led out of the mixing turbine; and having a collecting device for collecting oil and water separated out from the distillation device.

Such a method and such an apparatus are known, for example, from EP 1 798 277, DE 100 49 377 and DE 10 2005 056 735. The aforementioned publications disclose the ambient-pressure catalytic conversion of hydrocarbonaceous substances in mixing turbines. In this prior art, the mixing turbines have a rotor or drum rotor that rotates in the mixing turbine and generates heat via friction with the hydrocarbonaceous substance present in the mixing turbine. Such a rotor has to be driven separately, which consumes energy. The heat generated by friction provides the reaction temperature in order to initiate the ambient-pressure catalytic conversion of the hydrocarbonaceous substances in the respective mixing turbine.

In the context of the present invention, hydrocarbonaceous substances are, for example, mineral oil, mineral oil residues, coal, biomass and waste, which are mixed together with a catalyst oil in the prior art mixing turbine and heated to a reaction temperature of about 240 to 340° C. “Substance” in the context of the invention means not just a single substance but also a mixture of individual substances. “Catalyst oil” means an oil into which the substance is mixed in order to make it more free-flowing. It may be a product of the method which is used for the purpose or it may be an oil extraneous to the method. The catalyst oil preferably forms through addition of a catalyst composed. of cation aluminosilicate and lime or limestone for neutralization of acids present in the catalyst oil. The catalyst is additionally also present in coal, and so the above addition of catalyst can also be replaced by addition of coal, which then has the advantage that product (diesel) thus additionally forms and the method becomes cheaper.

The mechanical complexity for sole provision of the heating energy for attainment of the reaction temperature for the catalytic oxidation is very high. In the prior art, an electric motor or a diesel engine is provided for the purpose. The reaction temperature generated in this way lowers the efficiency of such a method or such an apparatus and requires long heating times. Some of the fuel generated is used again straight away for conversion of mechanical energy to heat.

The problem addressed by the present invention is therefore that of distinctly improving the efficiency of the method specified at the outset and the apparatus specified at the outset.

The problem is solved in accordance with the invention for the method in that the step of mixing comprises introducing oxygen into the mixing turbine.

The problem is solved in accordance with the invention for the apparatus in that the mixing turbine has a second feed for oxygen.

It has now been found that, surprisingly, by the applicant, in the plants of the above-cited prior art, highly reactive intermediates are formed in the catalytic conversion of hydrocarbonaceous substances, and these trigger a reaction even in the temperature region below 100° C. These intermediates then react very vigorously over and above 140° C. This surprising finding is also essentially in agreement with the way in which the human body is observed to work, which makes use of the lung to inject oxygen into the catalytic processes in human blood. The process described in the context of the present invention thus approximates the biological mechanism in the human body, in which the generation of mechanical energy and the energy consumed by the work of the brain are covered by energy supply from food. However, the mechanical energy is less important in the context of the present invention.

On the basis of the applicant's observation, in the context of the present invention, substitution of the heating of the mixture of catalyst oil and hydrocarbonaceous substances for the mechanical energy supplied to date by the mixing turbine, i.e. the heart of the catalytic oxidation, is now achieved in accordance with the invention in the mixing turbine, specifically by the catalytic oxidation with injection of oxygen.

Of fundamental importance here are the heating initiated by the injection of oxygen and the proportion of the heating generated by friction of a turbine wheel of the mixing turbine.

A further advantage of the present invention is therefore that an amount of oxygen to be introduced is controlled as a function of a reaction temperature in the mixing turbine. This makes it possible to set any ratio between the proportions of the two aforementioned introductions of heat.

For example, it is advantageous that the amount of oxygen increased in the event of a declining reaction temperature in the mixing turbine in the downstream direction.

It is likewise advantageous that the amount of oxygen is reduced in the event of a rising reaction temperature in the mixing turbine in the downstream direction.

The injection of the oxygen or of the air enables substitution of the mechanical energy of the mixing turbine with regard to the heating and the attainment and retention of the reaction temperature of up to 90%. This means that fuel required for provision of the 90% from mechanical energy can be dispensed with. The efficiency of the method and of the apparatus according to the present invention is distinctly increased as a result.

A further advantage of the present invention is that the oxygen to be introduced is oxygen with a purity level of more than 90%. Thus, if not just air but oxygen with a high purity level is used in the context of the present invention, substitution of the mechanical energy of the mixing turbine with regard to the heating and the attainment and retention of the reaction temperature of up to 95% is even enabled.

A further advantage of the present invention is that the injection of oxygen in very pure form lowers the required reaction temperature for the catalytic oxidation of the mixture of catalyst oil and hydrocarbonaceous substances present in the mixing turbine by 10 to 20° C. This is ascribed to the stripping effect of the nitrogen.

One embodiment of the present invention is described in detail hereinafter with reference to the sole FIGURE.

The FIGURE shows a schematic view of an apparatus for catalytic ambient-pressure conversion of hydrocarbonaceous substances to oil according to the present invention.

The FIGURE shows, in schematic form, a mixing turbine 1 in which a rotor or drum rotor 3 is mounted so as to rotate about an axis of rotation. The drum rotor 3 in the present embodiment has a diameter of 500 mm and rotates at 3000 rpm. The drum rotor is driven by an electric motor with a power of 300 kW. The mixing turbine 1 has a first feed 5, via which a hydrocarbonaceous substance or a mixture of hydrocarbonaceous substances can be supplied to the mixing turbine 1. It is additionally also possible to supply a catalyst oil via the first feed 5. In other embodiments, the catalyst oil can also be introduced into the mixing turbine 1 via a dedicated feed. The catalyst oil is there to make the hydrocarbonaceous substances free-flowing in the mixing turbine 1. The rotation of the drum rotor 3 mixes the hydrocarbonaceous substances with The catalyst oil. Friction energy generates heat.

The mixing turbine 1 additionally has a second feed 7 via which oxygen can be introduced into the mixing turbine 1. In the preferred embodiment, the oxygen has a purity level of more than 90%. But the present invention already has an advantage when an oxygen mixture, for example air, is introduced into the mixing turbine 1 via the second feed 7. Oxygen is introduced during operation of the mixing turbine 1, i.e. generally during rotation of the drum rotor 3. Owing to the supply of oxygen via the second feed 7, only a power of 100 kW is called for by the electric motor in sustained operation. The reason for this is that an amount of oxygen of 400 m³/h supplied via the second feed 7 to the mixing turbine 1 releases heating energy to the mixture of catalyst oil and hydrocarbonaceous substance(s) that corresponds to a power of 1000 kW. With this energy from the air input via the second feed 7 and the rotation of the drum rotor 3, the catalytic oxidation generates liquid constituents and the outlet 9 transfers them into a distillation device 11. At the end of the distillation device 11, in the present embodiment, oil and water are collected by means of a condenser device 13. Overall, an amount of oil (amount of diesel) of 2.5 m³ is evaporated out of the mixture in the mixing turbine 1 as a result of the catalytic oxidation. Only 0.075 m³ of the amount of oil is converted to CO₂ and H₂O, and a further 0.025 m³ of the amount of oil is used for the operation of the electric motor and the provision of a power of 100 kW in a combined heat and power plant.

In the present embodiment, the second feed 7 has been provided with an opening 7.1 having a diameter of 1 inch. The second feed 7 is connected to a pressure device 14 that generates oxygen or pressure or compressed air. The first feed 5 and the outlet 9 from the mixing turbine 1 are disposed on the mixing turbine 1 such that suction and discharge of the material in the mixing turbine 1 initiate a vortex. In the present embodiment, the arrangement of the first feed 5 and the outlet 9 tangentially on the mixing turbine 1 is envisaged.

The distillation device 11 is at least one so-called distillation column connected via conduits 11.1 to the condenser device 13. This condenser device 13 has fins 13.1 on a vapor side in order to improve heat transfer in spite of the gas component. The condenser device 13 is connected to a large collecting vessel 15 such that a condensation mixture is guided into the collecting vessel 15 without further mixing. The two products, water and oil (diesel), can calmly settle out in the collecting vessel 15. The connection between the condenser device 13 and the large collecting vessel 15 is made by lateral shafts having holes to the collecting vessel 15.

In the collecting vessel 15 there are conductivity sensors (not shown) that indicate the level between oil (diesel) and water. In the lower portion of the collecting vessel 15 there are first conduits 15.1 for the water in order to remove it for water treatment. Above that are second conduits 15.2 that recycle the oil component (diesel component) into the distillation device 13. This recycling of the diesel component is effected after the level of the diesel oil has been lowered by removal of water to a height below a diesel exit opening. Collecting vessel sizes for the apparatus of the invention have a volume of 20 m³, and so a production rate of 2.5 m³/h is possible.

The further distillation in the distillation device 13, for a production rate of 2.5 m³/h, is effected in an electrically heated tank, for which electrical heating with a power of 500 kW is provided. Around the electrically heated tank are disposed evaporator tubes. A total of 50 electrically heated evaporator tubes each with an individual power of 10 kW are disposed around the tank, each of which has a volume of 10 m³. A downstream air-cooled condenser likewise has a cooling power of 500 kW.

### LIST OF REFERENCE NUMERALS

1 mixing turbine
3 rotor/drum rotor
5 first feed
7 second feed
7.1 opening
10 outlet
11 distillation device
11.1 conduits
13 condenser device
13.1 fins
14 pressure device
15 collecting vessel
15.1 first conduit
15.2 second conduit
17 control device

1. A method of catalytic ambient-pressure conversion of hydrocarbonaceous substances to oil, comprising the steps of:
providing a hydrocarbonaceous substance and a catalyst oil in a mixing turbine;
mixing the catalyst oil with the hydrocarbonaceous substance to give a mixture; where the step of mixing comprises producing heat for a catalytic oxidation in the mixing turbine;
providing a distillation device downstream of the mixing turbine;
removing liquid constituents of the mixture into the distillation device;
distilling the liquid constituents; and
collecting oil and water,
characterized in that
the step of mixing comprises introducing oxygen into the mixing turbine.

2. The method as claimed in claim 1,
characterized in that
an amount of oxygen to be introduced is controlled as a function of a reaction temperature in the mixing turbine.

3. The method as claimed in claim 2,
characterized in that
the amount of oxygen is increased in the event of a declining reaction temperature in the mixing turbine in the downstream direction.

4. The method as claimed in claim 2,
characterized in that
the amount of oxygen is reduced in the event of a rising reaction temperature in the mixing turbine in the downstream direction.

5. The method as claimed in claim 1,
characterized in that
the oxygen to be introduced is oxygen with a purity level of more than 90%.

6. The method as claimed in claim 2,
characterized in that
the the reaction temperature in the mixing turbine is lowered by the introduction of oxygen.

7. An apparatus for catalytic ambient-pressure conversion of hydrocarbonaceous substances to oil, having:
a mixing turbine (1) comprising a first feed (5) for a catalyst oil and at least one hydrocarbonaceous substance and an outlet (9) for liquid constituents after a catalytic oxidation;
having a distillation device (11) for distilling the liquid constituents led out of the mixing turbine (1); and
having a collecting device (15) for collecting oil and water separated out from the distillation device (11);
characterized in that
the mixing turbine (1) has a second feed (7) for oxygen.

8. The apparatus as claimed in claim 7,
characterized in that
the second feed (7) is coupled to an oxygen generation device.

9. The apparatus as claimed in claim 7,
characterized in that
a control device (17) controls an amount of oxygen flowing through the second feed into the mixing turbine.

10. The apparatus as claimed in claim 7,
characterized in that
the second feed (7) is disposed in a middle region of the mixing turbine (1).
